(19) United States
(12) Patent Application Publication
(10) Pub. No.: US 2025/0029100 A1
(43) Pub. Date: Jan. 23, 2025

(54) MESSAGING PROTOCOL FOR NEAR-REAL TIME TRANSACTION IDENTIFICATION

(71) Applicant: Involute Inc. (doing business as XUNO), Ellensburg, WA (US)

(72) Inventors: Bal Krishna Joshi, Tigard, OR (US); Pawal Adhikari, Kathmandu-4 (NP); Meshuka Rayamajhi, Kathmandu-3 (NP); Rupesh Krishna Shrestha, Kathmandu-3 (NP)

(21) Appl. No.: 18/776,519

(22) Filed: Jul. 18, 2024

Related U.S. Application Data
(60) Provisional application No. 63/514,665, filed on Jul. 20, 2023.

(51) Int. Cl. G06Q 20/40; G06Q 40/03

(52) U.S. Cl. CPC G06Q 20/401; G06Q 40/03

(57) ABSTRACT

A messaging system configured to facilitate cross-border transactions between parties. A Requester, or associated agent, can transmit a request message to a request message platform that provides information indicating the Requester, a Requestee, and the requested transaction. The request message platform can perform various screenings regarding the parties and the requested transaction, including screenings based on regulations of the jurisdictions in which the parties, or their agents, are located. The request message platform can also convert the request message, or the associated request, to a pertinent messaging protocol used for such transactions in the corresponding jurisdictions, and assist in providing status updates regarding the transaction to the parties. The messaging system can also facilitate messaging to the Requestee, including messaging that can direct the Requestee to a landing page at which the Requestee can log into the system, receive information regarding the requested transaction, and accept or deny the request.

### TECHNICAL FIELD

The present disclosure generally relates to a messaging system, and, more particularly, but not exclusively, to a messaging system for near real-time identification, verification, and secure communications of information pertaining to cross-border transactions.

### BACKGROUND

Cross-border transactions, such as financial transactions, can often involve a transmission of a monetary amount to an individual or entity in one country from another individual or entity in another, or different, country. The beneficiaries of such transactions, including, but not limited to, those that reside in portions of the world that may be underserved in terms of financial services, can have little, if any, control or visibility to/of the money or funds that the beneficiary is to receive from such cross-border transactions. Further, in at least certain instances, to the extent beneficiaries of such transaction have options for receiving cross-border payments or funds, such options can be quite expensive or take relatively long periods of time for completion. Such transactions can further be complicated by different domestic rules, regulations, and/or laws, which can further delay and adversely impact the transparency of such cross-border transactions, including the transparency for at least the beneficiaries and institutions that may be involved in such transactions.

### SUMMARY

The present disclosure may comprise one or more of the following features and combinations thereof.

In one embodiment of the present disclosure, a method is provided for messaging communications for cross-border transactions. The method can include receiving a request message from a requester agent of a requester that can identify a request being made by the requester for a requestee and which can also provide information to identify the requester. The method can also include screening the requester identified by information provided by the received request message with respect to one or more first regulations of at least one jurisdiction implicated by the request message. Additionally, the requestee identified from the received request message can also be screened with respect to one or more second regulations of the at least one jurisdiction, and the request identified from the received request message can be screened with respect to one or more third regulations of the at least one jurisdiction. Additionally, the request from the received request message can be converted to a request message protocol based on a request type of the request and the at least one jurisdiction. The method can also include generating, in response to a result of the screenings of the requestee, requester, and the request, a signal to facilitate an electronic transmission of a request notification message to a requestee communication device of the requestee. Additionally, the using the request message protocol, information regarding the request can be communicated for viewing by the requestee on the requestee communication device.

In another embodiment, a messaging system for cross-border transactions is provided that can include a request message platform comprising at least one historical database and a screening analyzer. The screening analyzer can comprise at least one processor and a memory coupled with the at least one processor. The memory can include instructions that when executed by the at least one processor cause the at least one processor to receive a request message from a requester agent of a requester, the request message identifying a request being made by the requester for a requestee and providing information to identify the requester. Additionally, the memory can include instructions that when executed by the at least one processor can further cause the at least one processor to: screen the requester identified by information provided by the received request message with respect to one or more first regulations of at least one jurisdiction implicated by the request message; screen the requestee identified from the received request message with respect to one or more second regulations of the at least one jurisdiction; and, screen the request identified from the received request message with respect to one or more third regulations of the at least one jurisdiction. Further, the memory can include instructions that when executed by the at least one processor can further cause the at least one processor to convert the request from the received request message to a request message protocol based on a request type of the request and the at least one jurisdiction, and generate, in response to a result of the screenings of the requestee, requester, and the request, a signal to facilitate an electronic transmission of a request notification message to a requestee communication device of the requestee. The memory can also include instructions that when executed by the at least one processor can further cause the at least one processor to communicate, using the request message protocol, information regarding the request for viewing by the requestee on the requestee communication device.

These and other features of the present disclosure will become more apparent from the following description of the illustrative embodiments.

### BRIEF DESCRIPTION OF THE FIGURES

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an exemplary embodiment of a request-to-pay system.

FIGS. 2A, 2B, and 2C illustrates a simplified flow chart of a method that can be performed in connection with the request-to-pay system in response to receipt of a request for a transaction from a Requester and/or from an agent of the Requester.

FIG. 3 illustrates a portion or subsystem of the request-to-pay system shown in FIG. 1.

FIGS. 4, 5, and 6 each illustrate simplified flow charts of methods that can be performed in connection with the request-to-pay system.

### DETAILED DESCRIPTION OF THE ILLUSTRATIVE EMBODIMENTS

The following Detailed Description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the Detailed Description is not meant to limit the embodiments described below.

In the Detailed Description herein, references to “one embodiment”, an “embodiment”, and “example embodiment”, etc., indicate that the embodiment described may include a particular feature, structure, or characteristic, by every embodiment may not necessarily include the particular feature, structure, or characteristic. Moreover, such phrases are not necessarily referring to the same embodiment. Further, when a particular feature, structure, or characteristic may be described in connection with an embodiment, it may be submitted that it may be within the knowledge of one skilled in art to affect such feature, structure, or characteristic in connection with other embodiments whether or not explicitly described.

Embodiments of the subject application generally provide systems and methods for providing at least near real-time, if not real-time, interactions between institutions, including, but not limited to, financial institutions and/or non-financial institutions, involved the sending and receipt of funds, including, but not limited to, digital financial transactions. Moreover, embodiments discussed herein provide a messaging overlay solution that can be integrated for use with existing electronic messaging standards and exchanges, including, for example, ISO 20022, among others, in a manner that can increase at least near real-time compliance visibility of individuals and businesses across borders, including with respect to international transactions, which can thereby reduce payment frictions.

The at least near real-time compliance visibility of individuals and businesses provided by the request-to-pay system discussed herein can include upfront visibility regarding account details, including with respect to beneficiary accounts, as well as in terms of applicable regulations, including, for example, local, state, federal, or national regulations, rules, guidelines, and/or laws, among others. Such upfront visibility of account and regulation details can avoid, for example, potential issues associated with: inaccurate beneficiary details; delayed screening results regarding the requested transaction and associated parties; failure to comply with jurisdictional reporting requirements, including those involving limits on transactions and suspicious transaction filing requirements; and/or, inaccessible beneficiary accounts, such as, for example, beneficiary accounts that have been deemed invalid due to dormancy or are blacklisted, including, for example, due to at least suspicious related activity(ies). Indeed, embodiments of the subject disclosure can avoid transaction failures that could otherwise result form a lack of transparency of at least the parties involved in a transaction, let alone failures that can be attributed to upfront identification of inaccurate and/or incomplete information relating to one or more identities, account details, and/or payment instruments, among other information.

Accordingly, embodiments discussed herein provide a request-to-pay system for avoiding discrepancies in at least certain types of transactions by providing upfront, and in at least near real-time, visibility regarding pertinent details of a transaction. For example, with respect to cross-border financial transactions, the request-to-pay system can be configured to automatically ensure, including check, information has been provided to the request-to-pay system that is sufficient to comply with the customer, also referred to herein as Requester, payee client, or beneficiary, including customer representative, agent, and/or institution, identification requirements or guidelines in the pertinent jurisdiction(s), including, country(ies). Thus, with respect to transactions that can involve a financial services entity, including a bank, among others, in the United States, the request-to-pay system can be utilized to confirm sufficient customer identification information has been provided to comply with identification guidelines or regulations in the United States, including, for example, guidelines and regulations relating to Know Your Customer (KYC) requirements, among others. For example, in addition to confirming customer identification information sufficient to comply with at least one financial instruction regulation, such as, for example, KYC requirements for transactions involving the United States, embodiments discussed herein can be used to confirm adequate information has been provided upfront to comply with one or more of Know Your Customer's Customer (KYCC), Know Your Business (KYB), and electronic know your customer (eKYC) regulations. However, the particular customer identification regulations, among other regulations, evaluated or screened for the cross-border request being made by the client can be tailored by the request-to-pay system based on the involved jurisdiction(s). Thus, while for certain embodiments the request-to-pay system can evaluate, upfront, customer information relating to KYC regulations for transactions involving the United States, one or more regulations of other countries can instead be identified and used in the evaluation of the provided information by the request-to-pay system for transactions involving countries other than the United States.

The request-to-pay system can also be configured to identify one or more jurisdictions involved in transactions that use the request-to-pay system. Based at least on the identified jurisdiction, and an identification of the type or purpose of the transaction being sought by a request received by the request-to-pay system, the request-to-pay system can identify the pertinent message format or protocol used by the identified jurisdiction for the particular type of transaction being sought by the request. For example, according to embodiments in which the request-to-pay system receives a request regarding a cross-border financial transaction that may involve a person or entity in the United States, the request-to-pay system can identify that messaging relating to such a transaction should be in the ISO20022 messaging protocol. Thus, the request-to-pay system can be configured to convert messages or information provided for such a transaction, including information regarding a request by a Requester or associated agent of the Requester, to the ISO20022 messaging protocol. By converting messaging to the ISO20022 messaging protocol, the request-to-pay system can provide benefits with respect to facilitating financial management for individuals and businesses, can assist in enhancing fraud detection by associated fraud detection systems or screenings, leverage data insights to improve customer service, and potentially eliminate payment frictions in connection with enhancing the overall customer experience.

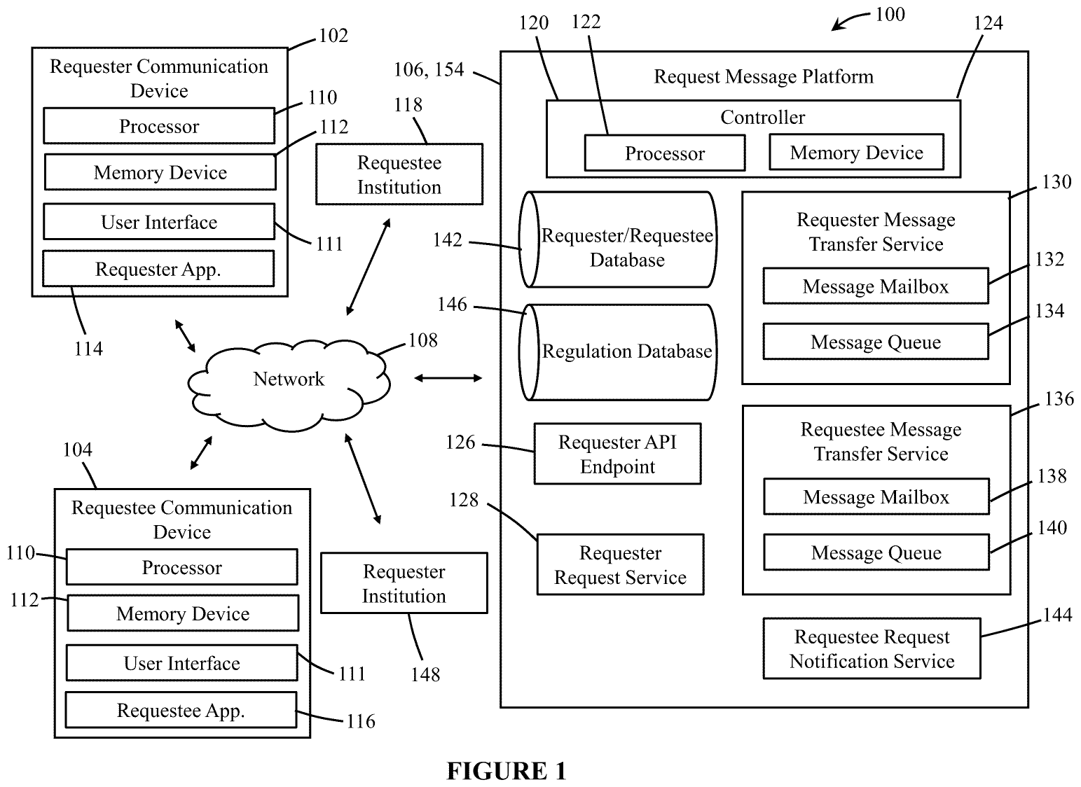

FIG. 1 illustrates an exemplary embodiment of a request-to-pay system 100. As shown, the request-to-pay system 100 can include, for example, a requester communication device 102, a requestee communication device 104, a request message platform 106, and a network 108. Either or both the requester communication device 102 and the requestee communication device 104 can include a processor 110, a memory device 112, and a network interface. According to certain embodiments, the requester communication device 102 and/or the requestee communication device 104 can be a mobile telephone, smartphone, workstation, portable computing device, other computing device, such as, for example, a laptop, desktop computer, cluster of computers, set-top box, and/or any other suitable electronic device that can transmit and receive one or more types of messages to/from the request message platform 106 via the network 108. The requester and requestee communication devices 102, 104 can be configured to communicate via the network 108 in a variety of different manners, including, for example, via use of one or more types of message protocols, including, for example, in-app messages, short message service (SMS), multimedia messaging service (MMS), instant messaging, push notifications, rich communication services (RCS), and/or an email protocol, among other messaging protocols.

The requester communication device 102 and the requestee communication device 104 can each include a requester app. 114 (e.g., software application) and a requestee app. 116, respectively, that is configured to communicate with at least the request message platform 106. One or both of the requester app. 114 and the requestee app. 116 can be dedicated for use with the request-to-pay system 100, or can be provided by a third party that partners for use of the request-to-pay system 100, including, for example, an institution or agent associated with the Requester and/or Requestee. The type of messaging protocol used by the requester app. 114 and the requestee app. 116 can be based on the type of associated transaction being used with the requester and requestee apps. 114, 116. For example, with respect to financial transactions, the messaging protocol for a message, such as, for example, a request message, being communicated to, or from, either the requester communication device 102 and/or the requestee communication device 104 can utilize a messaging protocol used for financial transactions, including, for example one or more of: Request to Pay (RTP); Request 2 Pay (R2P); Request for Payment (RfP); a Nepal Clearing House Limited (NCHL) protocol; Collect UPI; social payments, recurring payments, and bill payments (P2P); invoicing/billing, payroll, and recurring payments (B2B); freelance payments and one-time payments (B2P); and, e-commence invoicing/billing, point-of-sale, and service payments (P2B), among others. The particular protocol utilized by either or both the requester and requestee communication devices 102, 104 can be based on a variety of criteria, including, for example, the jurisdiction (e.g., country) in which the requester communication device 102 or the requestee communication device 104 are located.

A Requester, such as, for example, an individual or entity, can use the requester communication device 102, including the requestee app. 116, to at least initiate a transmission of a request message for communication via the network 108 to the request message platform 106. Additionally, or alternatively, a requester agent or institution 118 of the Requester can collect and/or retrieve information regarding the Requester and the request being sought by the Requester, and communicate that information via a request message to the request message platform 106. As mentioned above, according to certain embodiments, the requestee app. 116 can be associated with, including dedicated for, the request message platform 106, or can be associated with another entity, which can be, for example the requester agent or institution 118, that can partner with the request message platform 106. A variety of different types of entities can be utilized as the requester institution 118, including, for example, financial and non-financial institutions, such as banks, bank clearing houses, payment service providers (PSP), automatic clearing houses (ACH), and payment system operators (PSO), among others. Thus, while the requester communication device 102, including, for example, the requestee app. 116 may be used to at least facilitate a generation of the request message, the request message may be generated and/or communicated via the network 108 to the request message platform 106 either by the requester communication device 102 or the associated requester institution 118.

The request message platform 106 can evaluate the request message, including a request, such as a financial transaction, being requested by the Requester that the Requester and/or the requester institution 118 communicated to the request message platform 106 via the request message. Additionally, the request message platform 106 can use information provided in, or by, the request message to identify the Requester, as well as the identify of a Requestee, such as, for example, another person or entity, to which the request is being made. Additionally, based on a result of one or more screenings, including evaluations, by, and/or for, the request message platform 106, the request message platform 106 can communicate, via the network, information regarding the request to the Requestee for approval, and/or to the Requester or requester institution 118 regarding a denial by at least the platform 116 of the Requester's request.

The request message platform 106 can include a controller 120 having one or more processors 122 and one or more memory devices 124. The processors 122 can be embodied as any type of processor or other compute circuit capable of performing various tasks such as, for example, in connection with generating, analyzing, and facilitating the communication of messages and/or transactions in association with various aspect of the request message platform 106 and/or the associated request-to-pay system 100. In some embodiments, each processor 122 can be embodied as a single or multi-core processor, a microcontroller, or other processing or controlling circuit. Additionally, in some embodiments, each processor 122 may be embodied as, include, or be coupled to an FPGA, an application specific integrated circuit (ASIC), reconfigurable hardware or hardware circuitry, or other specialized hardware to facilitate performance of the functions described herein. In some embodiments still, each processor 122 can be embodied as a high-power processor, an accelerator co-processor, an FPGA, or a storage controller.

Each memory device 124 can be embodied as any type of volatile (e.g., dynamic random-access memory (DRAM), etc.) or non-volatile memory capable of storing data therein. Volatile memory can be embodied as a storage medium that requires power to maintain the state of data stored by the medium. Non-limiting examples of volatile memory can include various types of random-access memory (RAM), such as dynamic random-access memory (DRAM) or static random-access memory (SRAM). In some embodiments, each memory device 124 can be embodied as a block addressable memory, such as those based on NAND or NOR technologies. Each memory device 124 can also include future generation nonvolatile devices or other byte addressable write-in-place nonvolatile memory devices. Additionally, in some embodiments, each memory device 124 can be embodied, or otherwise include, a memory device that uses chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. Each memory device 124 can refer to the device itself or to a packaged memory product. In some embodiments still, 3D crosspoint memory can comprise a transistor-less stackable cross point architecture in which memory cells sit at the intersection of word lines and bit lines and are individually addressable and in which bit storage is based on a change in bulk resistance. In some embodiments yet still, all or a portion of each memory device 124 can be integrated into the processor(s) 122. Regardless, each memory device 124 can store various software and data used during operation such as task request data, kernel map data, telemetry data, applications, programs, libraries, and drivers. Thus, the memory devices 124 can include information, including, but not limited to, algorithms and look-up tables, among other information, that can used by the processor 122.

The request message platform 106 can include a request application programing interface (API) endpoint 126 that can obtain information communicated by the requester communication device 102, including information or data communicated by the requester communication device 102 via use of the requester a pp. 114, and/or the requester institution 118. Additionally, the request message platform 106 can communicate such information received by the request message platform 106 to a requester request service 128, or other software, of the request message platform 106. The requester request service 128 can be configured to validate the information obtained by the request API endpoint 126, including, for example, validate the structure and data of the information obtained by the request API endpoint 126. For example, as discussed below, according to certain embodiments, from a request message communicated from the requestee communication device 104, the request API endpoint 126 can obtain information regarding a request contained in the request message, which the request API endpoint 126 can provide to the requester request service 128 for processing.

The request message platform 106 can further include a requester message transfer service 130 that, can include a message mailbox 132 and a message queue 134. The requester message transfer service 130 can be configured for storing and routing the request being made via the request message for processing and eventual communication to the Requestee. According to certain embodiments, the requester message transfer service 130 can include, or be in communication with, the message mailbox 132 which can, for example, be generally similar to an electronic message (e.g., e-mail) message box that can store the request being made via the request message. Additionally, the requester message transfer service 130 can be configured to, for each individual message (e.g., request), store one or more messages together, including, a thread of messages, at the messaging mailbox 132. Additionally, the requester message transfer service 130 can include a message converter that can be configured to convert the request from a first message format or protocol, such as, for example, a first protocol that is more commonly used in the jurisdiction (e.g.) in which the Requester, and the associate requester communication device 102, and/or requester institution 118 is located, to a second protocol that may be more commonly used in other jurisdictions or in the corresponding industry. For example, with respect to an example in which the Requester and/or requester institution 118 is located in Nepal, and the request being communicated in the request message from the requester communication device 102 and/or requester institution 118 includes a request relating to a cross-border financial transaction, the request message sent from the requester communication device 102 and/or requester institution 118 may have used a first format common for use in Nepal, including, for example, a Nepal Clearing House Limited (NCHL) protocol or Request to Pay (R2P) protocol. According to such an embodiment, the message converter can be configured to convert the request, or associated representation thereof, from being in the first protocol to another, or different, second protocol associated with a jurisdiction in which the Requestee or a requestee institution 148 reside, such as, for example, to the ISO20022 message format that is commonly used in financial transactions in at least some jurisdictions. The distributed message queue 134 of the requester message transfer service 130 can then be utilized in connection with the communication of the request message, or, moreover, the request or associated representation thereof, in the format converted by the message converter of the requester message transfer service 130, to, or for, the Requestee, including to the Requestee corridor.

The request message platform 106 can also include a requestee message transfer service 136 that can be synced with the requester message transfer service 130. Moreover, the requestee message transfer service 136 can include, or be configured to generate, the requestee message box 138 for the particular Requestee that is the subject of the current request. The requestee message box 138 can be configured to store one or more requests directed to the Requestee that can be provided by one or more of the above-discussed requests messages. For example, when a Requestee has, or is being set up, to use the request message platform 106, the Requestee can be assigned a unique personal identifier that the request message platform 106 can use to identify the particular, including individual, Requestee. In such situations, the request message platform 106 can use at least the unique personal identifier for the Requestee to identify, or set up, the requestee message transfer service 136 with an associated requestee message box 138 to which the request, or associated information, that was identified from the request message, can be communicated, including from, for example, the message queue 140 of the requester message transfer service 130 via the network 108. Additionally, or alternatively, the request message platform 106 can be configured to communicate, such as, for example, via the network 108, the request from the message queue 134 of the requester message transfer service 130 to a third-party application, or associated server, used by the Requestee. For example, with respect to a Requestee that has previously used the request-to-pay system 100, the request message platform 106 can have information, including, for example, information stored in a requester/requestee database 142, that can indicate information needed to route information, the request information for the Requestee. Depending on the identified third-party application, such information can be provided via a push notification, among other manners of notification. Additionally, or alternatively, the request message platform 106 can be configured to communicate, such as, for example, via the network 108, the request directly to the third-party application via a text message (e.g., short message service (SMS)) or electronic mail (e.g., email) among other communication protocols. Further, the requestee message transfer service 136 can include a message converter that can be configured to convert the request from a one format, such as, for example, the second format or protocol to another protocol being utilized (e.g., ISO20022 messaging format), for example, by the third-party application. The requestee message transfer service 136 can also include a message queue 140 for communicating the request, or representation thereof, from the requestee message transfer service 136 to a requestee request notification service 144.

The manner in which the requestee request notification service 144 receives the request information from the requestee message transfer service 136 can vary, and can be based, at least partially, on whether the Requestee has previously used, or been registered, including enrolled, with, the request-to-pay system 100. For example, with respect to Requestees enrolled with the request-to-pay system 100, the request-to-pay system 100, including, for example, the requester/requestee database 142, can include information relating to the particular third-party application that the information regarding the request is to be directed, including, for example, electronically sent as a message. As with other information that is retrievable by the request-to-pay system 100 from the requester/requestee database 142, the request-to-pay system 100 can retrieve the pertinent information in a variety of different manners, including, for example, based on an identification of the unique personal identifier associated with the particular Requestee. Alternatively, if the Requestee is not enrolled in the request-to-pay system 100, or the Requestee has a different preferred manner of receiving information regarding the request, the request-to-pay system 100 can electronically communicate a message, such as, for example, via a message sent by the request-to-pay system 100 to the requestee communication device 104 via use of the network 108, seeking to have the Requestee log into the request message platform 106 and enter, or otherwise provide, information indicating the software application that the Requestee requests the information regarding the request be sent for the Requestee to review. Such a software application, as identified by the Requestee, can include a software application used by the request-to-pay system 100, or be a software application provided by a third party that partners with the request-to-pay system 100. For example, according to certain embodiments, in response to a message received by the requestee communication device 104, the Requestee can log into the request-to-pay system 100, including, for example, an associated website or via use of the requestee app. 116, whereupon the Requestee can be directed to a unique landing page on the website or app. that can seek an identification from the Requestee as to which particular application the Requestee desires the request information be sent.

Thus, the requestee request notification service 144 can be utilized to communicate the request, or a representation thereof, from the corresponding request message to the requestee communication device 104, including to the requestee app. 116, for the Requestee to review. In response to reviewing the request at the requestee communication device 104, the Requestee can input, via the requestee app. 116, for example, a selection via a user interface 111 of the requestee communication device 104 indicating whether the Requestee approves or rejects the Requester's request.

Additionally, according to certain embodiments, the request-to-pay system 100 can establish an expiration time, including a time, time limit, or date, upon which the Requestee is to either accept or reject the communicated request. According to certain embodiments, such an expiration time can be preset or predetermined, including, for example, be a default time or time limit after communication to, or receipt of the request by, the Requestee. Further, according to other embodiments, the expiration time can be set, including modified, by either one or both of the Requester and the Requestee. Additionally, in the event the Requestee does not indicate either an acceptance or a rejection of the request by the expiration of the expiration time, the request-to-pay system 100 can deem the request as having expired, and the associated request can be withdrawn or terminated by the platform 106, or otherwise no longer available. In such an event, the request-to-pay system 100 can provide a notification to the Requester, requester institution 118, and/or the Requestee that the request-to-pay system 100 has terminated the request. Thus, in such an event, if the Requester is still interested in pursuing a request for an action, including, for example, a monetary transfer from the Requestee, the Requester will need to submit a new request or otherwise take actions to revive the prior request.

According to certain embodiments, in addition to being provided with the option of either accepting or rejecting the request from the Requester, the request-to-pay system 100 can provide the Requester with options that can enable the Requester to modify the request, such as, for example, by use of the requestee app. 116. Moreover, for example, the requestee app. 116 on the requestee communication device 104 can be configured to allow the Requestee to modify the request, and/or modify any terms or conditions from the Requester to the request. For example, according to embodiments in which the request relates to the Requester seeking a financial transfer of a monetary amount from the Requestee to the Requester, the Requestee can, for example via use of the requestee app. 116, accept the request but for an adjusted or modified monetary amount, including a greater or lesser monetary amount that is different than the monetary amount that was being sought by the Requester in the request. Additionally, or alternatively, rather than providing an approval or denial of the request, the request message platform 106 can accommodate the Requester responding to the request, for example, by use of the requestee app. 116, with a conditional denial in which the Requestee informs the Requester to re-submit or revive the request at a later date or time.

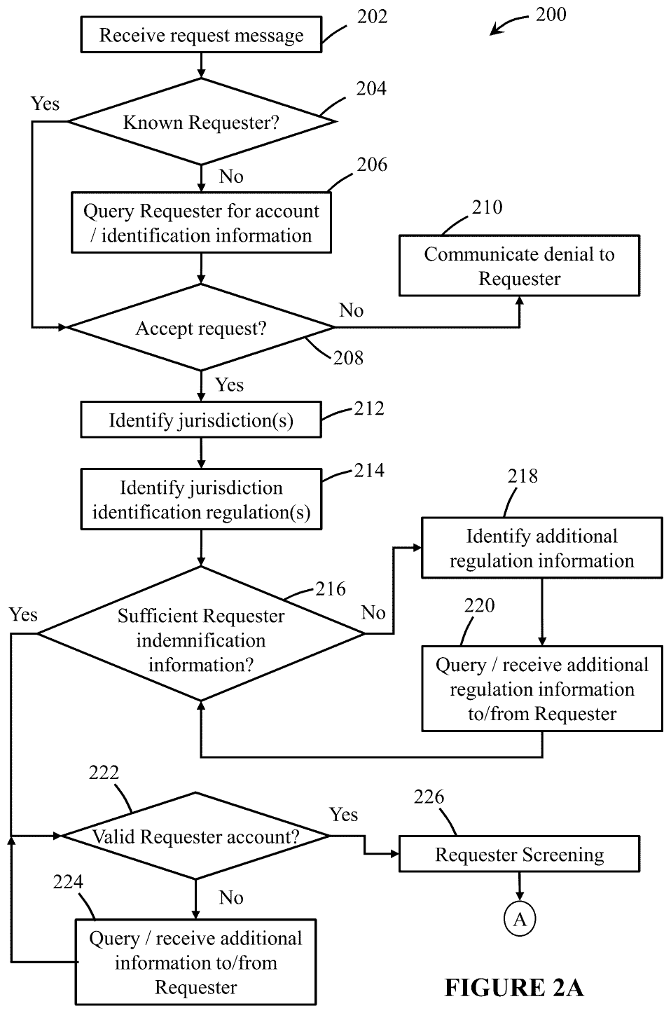

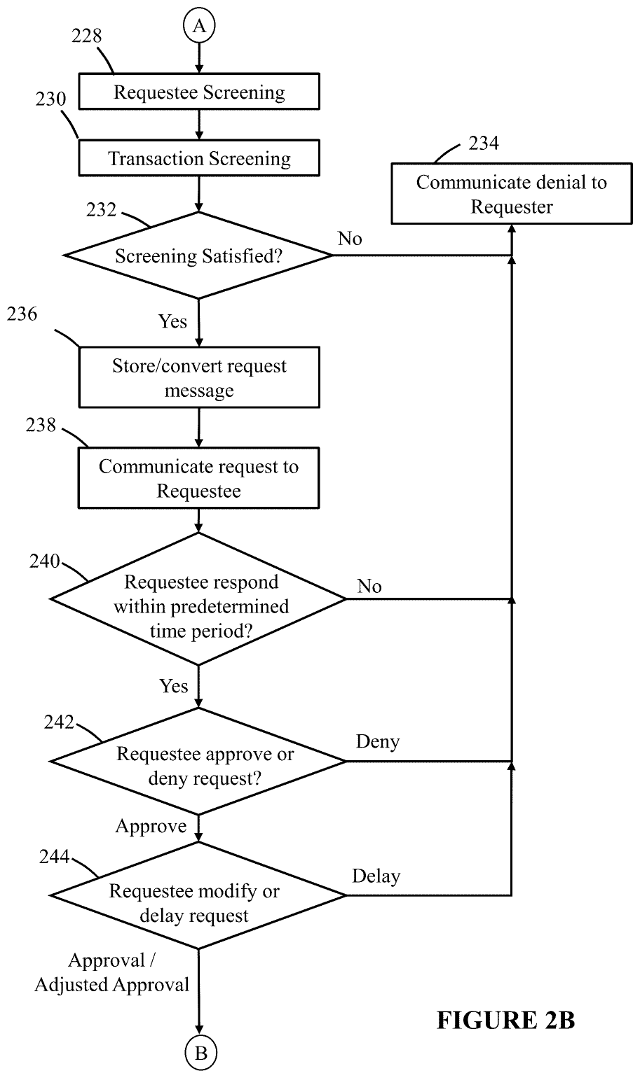

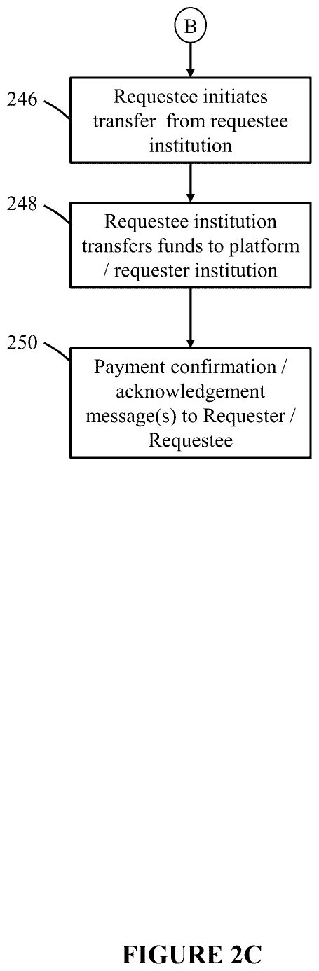

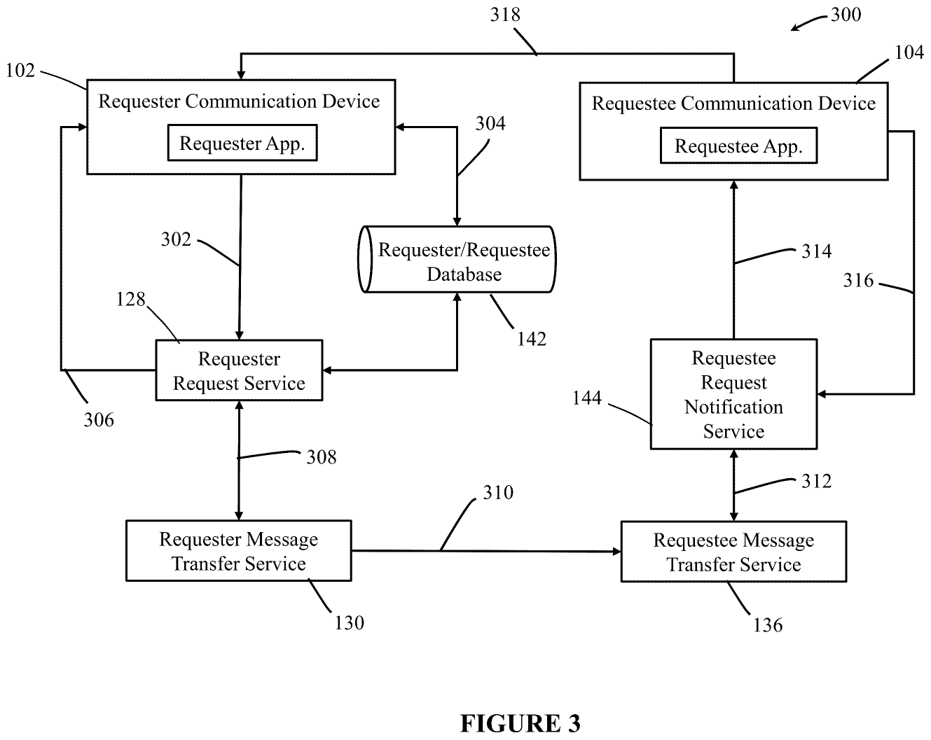

FIGS. 2A-2C illustrates a simplified flow chart of a method 200 that can be performed in connection with the request-to-pay system 100 in response to receipt of a request for a transaction from a Requester and/or from an agent of the Requester. The method 200 is described below in the context of being carried out by the illustrated exemplary request-to-pay system 100, a portion of which is shown by the subsystem 330 of the request message platform 106 shown in FIG. 3. However, it should be appreciated that method 200 can likewise be carried out by any of the other described implementations, as well as variations thereof. Further, the method 200 corresponds to, or is otherwise associated with, performance of the blocks described below in the illustrative sequence of FIGS. 2A-2C. It should be appreciated, however, that the method 200 can be performed in one or more sequences different from the illustrative sequence. Additionally, one or more of the blocks mentioned below may not be performed, and the method 200 can include steps or processes other than those discussed below.

At block 202, the request-to-pay system 100 can receive a signal, including, for example, a request message, indicating a Requester and/or an associated requester institution or agent 118 has initiated a message requesting use of the request-to-pay system 100. The request message can be initiated in a variety of different manners, including, for example, the Requester using the requester communication device 102 and/or communicated by an associated requester institution 118, as discussed above with respect to FIG. 1. Moreover, according to certain embodiments, as shown in FIG. 3, the request message, as indicated by line 302, can be initiated via use of the requester app. 114 that may or may not be dedicated for use with the request-to-pay system 100 that may be stored and/or operated at least on the requester communication device 102. For example, as previously discussed, according to certain embodiments, the requester app. 114 may be a software application that is associated with a requester institution 118 (e.g., a financial or non-financial institution) used by the Requester, or be a mobile wallet app. (e.g., eWallet), among other applications. Moreover, the requester app. 114, among other software, can be used to at least facilitate a generation and sending of the request message from the Requester and/or requester institution 118 to the request message platform 106, including, for example, to the requester request service 128 of the request message platform 106. According to such an embodiment, the received request message can include, in the body of the message, a request being made by the Requester.

The content of the request message being received by the request message platform 106 can at least be partially based on the type or characteristics of the request being made by the Requester to/for another individual or entity (e.g., Requestee). Additionally, the content of the request message can also be at least partially based on the nature of the Requester and/or Requestee, including, for example, whether either or both the Requester and Requestee are individuals, businesses, and/or other entities. For example, according to certain embodiments, the Requester can be an individual seeking, via the request message, a benefit, such as, for example, a transfer, including payment, of a monetary amount, among other financial transactions, from the Requestee. Thus, according to such an embodiment, the Requester can be a payee or beneficiary, while the Requestee can be a payer. In such an embodiment, the request message can include certain information regarding the Requester, which can generally be referred to herein as requester information, as well as certain information regarding the Requestee, which can generally be referred to herein as requested information.

For example, in at least certain instances, the request message can include requester information, such as, for example, the name of the Requester, address or other contact information regarding the Requester, a government issued identifier for the Requester (e.g., a social security number, drivers license number, passport number, and/or government identification number), and/or an identification of where the Requester is seeking to have requested funds or currency (e.g., money) transferred, such as, for example, an account number associated with a financial or non-financial information to which the Requester is seeking to have the funds transferred, among other information. Additionally, the request message can also include Requestee information, including, for example, a name, contact information (e.g., telephone number, email address, etc.), among other information.

Additionally, or alternatively, the request message can include a request for a specific payment, including monetary transfer or payment, for a Requestee, or a verified bank or mobile wallet account associated with the Requestee. The request can also indicate that the Requester is seeking that the transfer, including payment, of the funds occur by, or before, a specific date, which can be identified in the request message. Thus, the request message can include an identification of an amount of funds (e.g., money) the Requestee is requesting. According to certain embodiments, the Requester can further request that the transfer be in one or more currencies, including, but not limited to, U.S. Dollars, Nepalese Rupee, and/or Japanese Yen, as well as any combinations thereof, among other currencies. Additionally, the request can seek to have the transfer be at the current exchange rate, and/or that the current exchange rate be used for any associated transfer that happens within a certain time period, such as, for example, within a default time limit (e.g., twelve hours) that can be triggered from a selected occurrence, such as, for example, from the time the request message is submitted for processing by the request-to-pay system 100.

While the request message can, at times, provide either or both requester information and requestee information, according to certain embodiments, some, if not all, of the requester information and/or requestee information can be retrieved by the request-to-pay system 100, as generally indicated by lines 304 and 306 in FIG. 3. For example, with respect to certain Requesters and/or Requestees, at least some, if not all, of the associated requester information and/or requestee information may have been previously saved to the request-to-pay system 100, including for example, at one or more historical databases (generally referred to herein as a requester/requestee database 142). Thus, for example, if the request message received at block 202 relates to a financial transaction in which the Requestee is seeking a transfer of money from the Requestee, and the Requester and/or Requestee have previously been involved with another financial transaction involving the request-to-pay system 100, previously provided requester information and/or requestee information may be stored, or otherwise retrievable, by the request-to-pay system 100, including by the request message platform 106. Thus, as generally indicated by line 306 in FIG. 3, according to certain embodiments, the request message at block 202 can include, or be associated, with a requester identifier that is unique to at least the Requester that is stored, or otherwise retrievable, by the request-to-pay system 100, including, for example, by the request message platform 106. Additionally, according to certain embodiments, the request-to-pay system 100 can be configured to allow the Requester to conduct a search for prior Requestees, as generally indicated by line 304 in FIG. 3, that have been involved in prior transactions with the Requestee. According to such an embodiment, in the request-to-pay system 100, including the requester request service 128 can retrieve previously used information for that Requestee, as may, for example, be stored by the request-to-pay system 100, including, for example, by the requestee/requester database 142, that may be searchable and/or selectable by the Requester.

In response to the request message from block 202, including the unique requester identifier, the requester request service 128, including the associated controller 120, can determine at block 204 whether the request message platform 106 does, or does not, have such pertinent requester information and/or requestee information. If the controller 120 determines at block 204 that the request message platform 106 does not have the requester information and/or requestee information, then the controller 120 can generate one or more signals to facilitate a reply message being communicated to the Requester, and, moreover, to the requester communication device 102, and/or to the requester institution or agent 118 that requests the Requester provide the pertinent requester information and/or requestee information. The Requester can then, in response to the reply message, communicate, such as, for example, via the requester communication device 102, a response message that can provide the requester information and/or requestee information being sought by the request message platform 106.

At block 208, the request message platform 106, including, for example, the controller 120 associated with the requester request service 128, can evaluate information provided by the request message and the response message, if any, to determine whether to, at least initially, accept or decline the request being made by the Requester, as generally indicated by line 306 in FIG. 3. The request can, at block 208, be at least initially denied for a variety of different reasons, including, for example, based on prior evaluations of the requester information and/or requestee information. Additionally, or alternatively, according to certain embodiments, the Requestee may have previously submitted information indicating that the Requester is to no longer be permitted to request transactions involving the Requestee, thereby effectively blocking the Requester from successfully submitting requests to, or for, the Requestee. Accordingly, if the request is not approved at block 208, the request message platform 106, including, for example, the controller 120 of the request message platform 106, and/or the requester institution or agent 118 can generate one or more signals to facilitate the Requester, and, moreover, the requester communication device 102 or associated requester app. 116, receiving at block 210 a notification of denial of the Requester's request.

If the request is accepted at block 208, then the requester request service 128, including the associated controller 120, can proceed with validating the request, including, for example, validate the structure of the request and associated data, and authenticate the Requester, Requestee, and/or transactions, such as, for example, in terms of associated laws and regulations, including, for example, regulations relating to one or more of Know Your Customer (KYC), anti-money laundering (AML), and/or homeland security regulations, such as counter-terrorist financing (CTF) regulations, as well as various combinations thereof, among other regulations. According to certain embodiments, such processing of the request can be performed by the requester request service 128 of the request message platform 106.

For example, referencing FIGS. 2A-2C, the controller 120 can, at block 212, identify the associated jurisdictions, including, for example, countries, that may be involved in the requested transaction. For example, according to certain embodiments, the controller 120 of the request-to-pay system 100 can evaluate the requester information and the requestee information to identify which state or countries may be involved with the requested financial transaction. For example, according to certain situations, the Requester may be an individual, and/or have a requestee institution 118, in a first country, such as, for example, Nepal, that is seeking a transfer of funds from an institution of a Requestee and/or requestee institution or agent 152 that is in second country, such as, for example, the United States, to an account or other entity in that first country (e.g., Nepal). In such situations, each or both of the first and second countries (e.g., Nepal and/or United States) may have particular guidelines or regulations that are to be followed in connection with an authorization of such a cross-border transaction. For example, with respect to the United States, such a cross-border transaction may require compliance with Know Your Customer (KYC) financial regulations, guidelines, or statues, or rules among other federal or non-federal rules (collectively generally referred to herein as regulations). Thus, by identifying the jurisdictions that may be implicated in the requested financial transaction, the request-to-pay system 100 can be configured to identify, such as, for example, from a regulation database 146, among other sources, at block 214 the corresponding regulations that are to be followed in association with such a transaction.

Additionally, the identification of the associated regulations at block 214 can further include an identification of the requestee information and/or requester information, among other information, necessary for complying with, or otherwise used in evaluating compliance with, the identified regulation(s). The controller 120 can further be configured to evaluate whether the information provided by the request message, or otherwise stored by the request-to-pay system 100, is, or is not, sufficient for the evaluation of compliance with the regulation(s) identified at block 214. Moreover, in view of the requester information and/or requestee information previously provided to request-to-pay system 100, and the information needed for evaluation of the regulations identified at block 214, the controller 120 can determine at block 216 whether additional information is to be provided by the requester. Moreover, if the request-to-pay system 100 determines at block 216 that the system currently has insufficient information for determining whether the current request satisfies identified regulations, then at block 218, the controller 120 can identify the additional information that is to be provided by the Requester. At block 220, the controller 120 can generate one or more signals to facilitate a communication to the Requester, including, for example, to the requester communication device 102 and/or associated requester app. 114, requesting the Requester provide the additional information that was identified at block 218 as being needed to evaluate compliance with the identified regulations. Thus, for example, with respect to KYC regulations, at block 216 the controller 120 can identify whether the information currently available to the request message platform 106 is sufficient for screening one or more of the parties or associated transaction with respect to compliance with the KYC regulations, and if not, identify at block 218 the additional information needed for screening, including evaluating compliance with the KYC regulations. The information identified that block 218 as being needed for the KYC regulation screening can then be communicated to the Requester at block 220.

At least in response to information provided by the Requester addressing the query communicated at block 220, the controller 120 can reevaluate at block 216 whether the platform 106 has sufficient information to screening for compliance with the identified regulation(s) as identified at block 214. The process of screening, including evaluating, and, if necessary, re-evaluating whether the request-to-pay system 100 has sufficient information to determine compliance with the identified regulation(s) can be repeated until either the request message platform 106 can verify compliance with the identified regulation(s), or a predetermined number of attempts to evaluate compliance with the regulation(s) has been satisfied(s). If the controller 120 determines that the number of attempts to determine compliance with the identified regulation(s) has been reached without successfully determining compliance, then the controller 120 can, similar to block 210, generate a signal to facilitate notifying the Requester of a denial of the Requester's request.

At block 222, the controller 120 can determine whether the account information for the Requester that the Requester provided via the request message, or otherwise retrieved by the request message platform 106, including, for example, from the requester/requestee database 142 is, or is not, valid. The controller 120 can evaluate the validity of the identified or retrieved account information for the Requester in a variety of different manners. For example, according to certain embodiments, the controller 120 can compare the provided or retrieved account information with the account information used for prior successful transactions involving the Requester. Additionally, or alternatively, the controller 120 can evaluate the data or structure of the provided or retrieved account information, including, for example, whether the provided or retrieved account information has an appropriate number of digits or valid routing numbers, among other criteria. Further, according to certain embodiments, the request message platform 106 can perform a check of the Requester account information to determine if the identified account is valid, such as, for example, is active.

If the controller 120 determines at block 222 that the account information provided or retrieved for the Requester is not valid, such as, for example, inaccurate or pertains to a dormant account, then at block 224 the request message platform 106 can generate one or more signals to facilitate a communication, such as a message, to the Requester, including, for example, to the requester communication device 102, seeking additional, updated, or corrected account information for the Requester. The Requester can then take corrective actions to obtain, or input for the request message platform 106, corrected account information for the Requester, which can then be reevaluated by the controller 120 at block 222. According to certain embodiments, if the controller 120 is unsuccessful after a predetermined number of attempts in confirming the validity of the account information of the Requester, the controller 120 can generate a signal to facilitate a notification, including a message, to the Requester, and, more specifically, to the requester communication device 102, that the Requester's request is being denied.

If the requester request service 128, including the associated controller 120, determines, including confirms, at block 222 that the request message platform 106 has, or has been provided with, valid, including, accurate, information regarding the Requester's account, the controller 120 can engage in a screening of the Requester at block 226 and/or a screening of the Requestee at block 228. The screening(s) conducted by the requester request service 128 of either or both of the Requester and the Requestee can include one or more different types of investigations, critiques, and/or analysis of the Requester and/or the Requestee. For example, according to certain embodiments, such screenings can involve confirming the identity(ies) of the Requester and/or the Requestee, including, for example, confirming or verifying the identities being provided for the Requester and/or Requestee. Such screening can also involve application of the previously discussed requester information and/or requestee information, including, for example, with respect to at least block 216. Thus, at blocks 226 and/or 228 such verification can involve analysis with respect to international, federal, and/or local regulations, laws, and guidelines pertinent to the type of transaction being sought. For example, with respect to situations in which the request being made by the Requester relates to a financial transaction, such as, for example, a cross border transfer of funds from a Requestee in the United States, the analysis at either or both blocks 226 and/or 228 can involve verification of compliance with Know Your Customer (KYC) requirements, among other regulations and guidelines. Such screening can also include whether the identities of the Requestee or Requester are identified on any international, federal, or local lists, including, for example, watch lists, such as, for example, relating to potential terrorists, fugitives, missing persons, or criminal or illicit organizations, among other types of lists.

The requester request service 128, including the associated controller 120, can also, as indicated by block 230, perform a screening of the transaction being requested by the Requester for potential indicators of illicit activities. For example, according to certain embodiments, the requested transaction by itself, an identified purpose for the transaction, and/or based on a pattern or frequency of similar requests, can be used by the requester request service 128 to identify the transaction as potentially being part of an illicit activity, including, for example, money laundering or other fraudulent activities. Thus, for example, the transaction can be evaluated by the requester request service 128 at block 230 with respect to anti-money laundering (AML) and/or counter-terrorist financing (CTF) regulations, as well as other regulations relating to transaction threshold filings or suspicious transaction filing requirements, among other rules and regulations.

The particular screenings performed at one or more of least at blocks 226, 228, and 230 can be based on the particular regulations or rules of the jurisdiction(s) that may be implicated in the transaction being sought by the request, as previously discussed. If the requester request service 128 determines that there is a failure to satisfy one or more of the screenings of the Requester, Requestee, and/or the transaction at blocks 226, 228, and 230, respectively, then, as indicated by block 234, the requester request service 128, including the associated controller 120, can generate signal to facilitate a communication, including a message, as generally indicated by line 306 in FIG. 3, to the Requester or requester institution or agent 118 indicating that the Requester's request is being denied.

If, however, the screenings at blocks 226, 228, and 230 identify no apparent issues with respect to the Requester, Requestee, and the transaction, then, as generally indicated by line 308 in FIG. 3, the requester request service 128 can route the request message, and, moreover, the request, and associated information to the requester message transfer service 130. The requester message transfer service 130 can be responsible for storing and securely routing the request to the Requestee corridor. According to certain embodiments, as indicated by block 236, the request message, and, moreover, the request, can at least initially be stored by the message mailbox 132 of the requester message transfer service 130. The stored request message, and, moreover, the request, can then be converted, as also generally indicated by block 236, by a message converter of the requester message transfer service 130 to another format or message protocol that may be consistent with the type of transaction being processed by the request-to-pay system 100, as previously discussed. For example, according to embodiments in which the request relates to a financial transaction, including, for example, a cross-border financial transaction involving R2P, the message converter can convert the message to the ISO20022 message format that is commonly used in financial transactions, as previously discussed. However, the particular messaging format that the message converter converts the request message, and, moreover, the request, can vary, and can be based on a variety of different criteria. For example, while, with respect to certain embodiments, the message converter can convert the request message to the ISO20022 format for R2P type transactions, the message converter may be configured to convert the request message to other formats for other types of transactions and/or based on the particular messaging format being used in the identified jurisdictions (block 212) associated with the transaction. For example, while the United States, United Kingdom, and European Union may utilize the ISO20022 format for R2P type transactions, other jurisdictions may use different, or additional, formats. The message converter may therefore be configured for conversion of the request message or associated request, to different message formats that are pertinent for details or nature of the specific request being made by each Requester.

Following at least conversion of the message format or protocol (e.g., conversion to the ISO20022 message format) of the request message, and, moreover, of the request, the converted request can be communicated to, or for, the Requestee corridor at block 238. For example, as generally indicated by line 310 in FIG. 3, the requester message transfer service 130 can, according to certain embodiments, at block 238 communicate the request in the converted message format from, for example, the message queue 140 of the requestee message transfer service 136 to the message mailbox of the requestee message transfer service 136, as previously discussed. The requestee message transfer service 136 can also be configured to at least store the requests received for the Requestee.

According to certain embodiments, block 238 can include the message queue 140 of the requestee message transfer service 136 being used in connection with the requestee request notification service 144, as generally indicated by line 312 in FIG. 3, to communicate the request message, or request, to the Requestee, including to the Requestee communication device 104, as generally indicated by line 314 in FIG. 3. The manner in which the request message, or request, is communicated to the requestee communication device 104 can be dependent on a variety of criteria, including, for example, whether the Requestee is enrolled with the request-to-pay system 100. In instances in which the Requestee is enrolled with the request-to-pay system 100, information stored regarding the Requestee, including for example, by the Requester/requestee database 142, can be used to identify a particular application on the requestee communication device 104, such as a particular requestee app. 116, the request message platform 106, including the requestee request notification service 144, is to send the request message, including, for example, via a push notification API associated with that identified particular requestee app. 116. Alternatively, as previously discussed, a notification regarding the request message can, at block 238, be provided to the Requestee through a third-party messaging system, such as, for example, a mobile SMS message or email message, among other messaging protocols. According to such an embodiment, the notification can provide a link or other information that can be used to direct the Requestee, via use of the requestee communication device 104, to any particular landing page, including, for example, a particular website page at which the Requestee can sign in or register with the request-to-pay system 100 so as to gain information regarding the request being made by the Requester.

As indicated by block 240, according to certain embodiments, after receiving communication, including, for example, the request message or a notification pertaining to the request message, as discussed above, the request message platform 106 can start a timer, which can include a counter, to determine whether the Requestee does, or does not, provide a response to the request-to-pay system 100 within a predetermined time period. For example, according to such an embodiment, in the absence of a detection, including, by the controller 120, of a timely response from the Requestee within the predetermined time period, the controller 120 can terminate the request. In such an event, the controller 120, and generate a signal to facilitate a communication to the Requester and/or requester institution or agent 118 notifying the Requester and/or requester institution or agent 118 that the request has been denied or terminated, as indicated by block 234.

If, however, a determination is made at block 240 that a response has been timely received from the Requestee, the controller 120 can, at block 242, identify whether the response from the Requestee is an approval or denial of the request. If the response is determined to be a denial, then the controller 120 can terminate the request and generate a signal to facilitate a communication to the Requester and/or requester institution or agent 118 notifying the Requester and/or requester institution or agent 118 that the request has been denied or terminated, as indicated by block 234.

If the controller 120 determines the response from the Requestee is an approval of the request, but with modifications, then the controller 120 can identify those modifications at block 244. For example, with respect to a request of a transfer of funds from the Requestee to the Requester, the Requestee may modify the request such that the performance for the request, namely the transfer of funds, is to be delayed so as to occur at a later time or date then is being sought by the Requester. Depending on the extent of the delay, the controller 120 may determine that the extent or duration of the delay being sought by the Requestee should instead result in the Requestee's response to the Requester's request be treated as a denial of the request. In such a situation, the request-to-pay system 100 can generate a communication to the Requester and/or requester institution or agent 118 indicating that the Requester and/or requester institution or agent 118 is to resubmit a request, or revive the request, at a later time or date. According to other embodiments, the response from the Requestee can be identified at block 244 as corresponding to the Requestee agreeing to a modification of the request. For example, if the request from the Requester is for a transfer, including, for example, a payment, of a first amount of money from the Requestee to the Requester, the response by the Requestee to the request can instead be for a transfer of a second amount of money that is more, or less, than the first amount being sought by the Requester.

According to certain embodiments, if the Requestee modifies the request, such as, for example, changes the amount of money that is to be transferred for the Requester, or changes the timing of the transfer, among other changes, as well as combinations thereof, the request message platform 106 can generate a message to the Requester providing details of the modifications the Requestee has made. Additionally, according to certain bodies, such a notification of the modifications that is communicated to the Requester can also include an opportunity for the Requester to approve such modifications or reject such modifications. If the Requester rejects the modification(s) made by the Requestee, the request-to-pay system 100 can proceed with termination of the request that was being made by the Requester, and thereby prevent the occurrence of the associated requested transaction. If the Requester agrees to such a modification, the request can then be modified by the request message platform 106 to conform to the modifications agreed to by the Requester and Requestee.

If the transaction associated with the request is to proceed, including the request being deemed to be approved with or without modification by the Requestee, the Requestee can take steps to commence the performance of the requested transaction. For example, according to certain embodiments, at block 246, the Requestee can use the requestee app. 116 or other app. installed on, or otherwise accessible via use of the requestee communication device 104, to identify the requestee institution 148 and/or Requestee account at the requestee institution 148 from which the funds are to be withdrawn. Additionally, according to certain embodiments, the Requestee can identify, or confirm, the amount of funds that are to be withdrawn from the requestee institution 148.

The transfer of funds from the requestee institution 148 to the account at the requester institution, or, alternatively, to an intermediary account, including an intermediary account associated with, or managed by, the platform 106, can occur at block 248. According to certain embodiments, the request message platform 106, including for example, the controller 120 of the request message platform 106, can monitor whether, or when, such a transfer has, or has not, occurred. For example, according to certain embodiments, the controller 120, among other portions of the platform, can evaluate whether after one or more time periods the transfer of the funds have been received from the requestee institution 148 by the requester institution 118 and/or the intermediary account. According to such an embodiment, after expiration of one or more predetermined time periods without detection of a receipt of the funds that are to be transferred from the requestee institution 148, the controller 120 or other portion of the request message platform 106 can generate a signal to facilitate a communication being sent to platform to the requestee communication device 104 that reminds the Requestee to take actions to transfer the identified funds. Additionally, according to certain embodiments, after a predetermined number of reminders have been sent to the Requestee to facilitate the transfer of the funds, and/or upon expiration of a predetermined time period, the controller 120 or other portion of the request message platform 106 can terminate the request, and thereby terminate the requested transaction. In such an event, the request message platform 106 can generate a signal to facilitate a communication being sent to the requester communication device 102 and/or the requestee institution 118 that indicates the status of the transaction, including, for example, a status relating to non-receipt of requested funds and/or termination of the request based on a non-receipt of funds from the Requestee or requestee institution or agent 156.

At block 250, upon detection of the receipt of the transferred funds from the requestee institution 148 to the Requester account at the requester institution 118 and/or the intermediatory, and/or in response to an acknowledgment from the requestee institution 148 indicating the requestee institution 148 has transferred to the funds, one or more confirmation or acknowledgement messages can be generated by the request message platform 106 and communicated to the associated parties. For example, according to certain embodiments, a transaction confirmation message can be provided from the requestee institution 148 to the request message platform 106 indicating a transfer of funds to either an intermediatory account associated with the request message platform 106 or to the requester institution 118. The request message platform 106 can then communicate a transaction confirmation message to the requester institution 118, which can then communicate a transaction confirmation message to the requester communication device 102. Additionally, at various times throughout the process, the Requestee and Requester can communicate with each other via use of the associated requester and requestee communication devices 102, 104, as generally indicated by line 318 in FIG. 3. For example, via link 318, the Requestee can seek further clarification from the Requester regarding the request being made by the Requester.

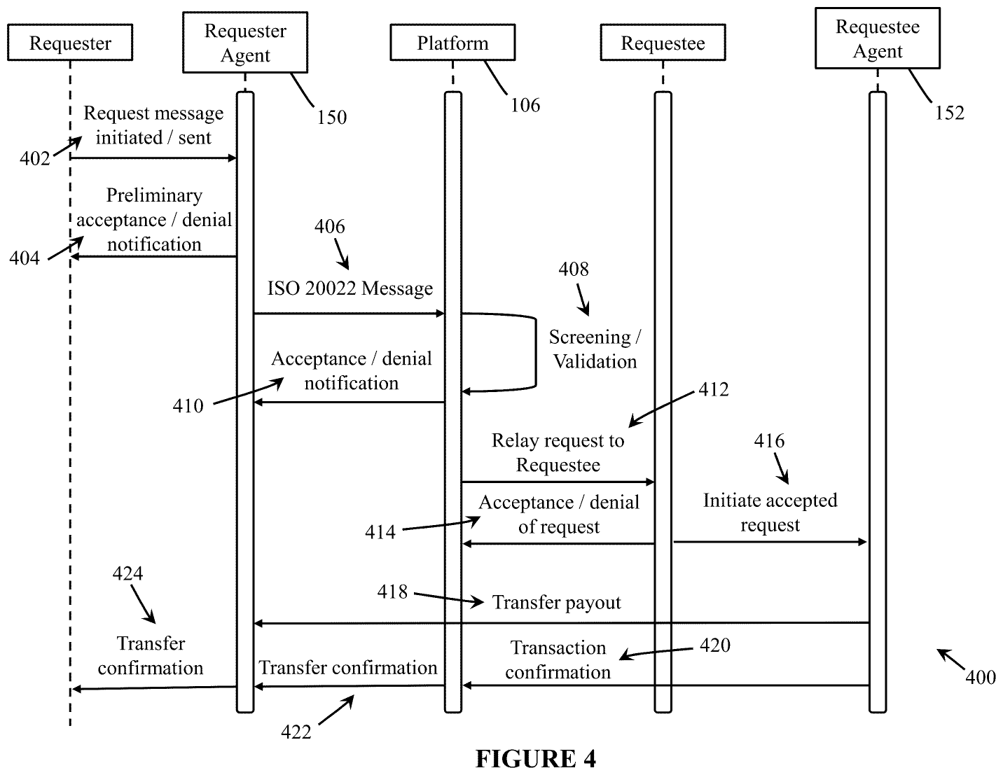

FIG. 4 illustrates a simplified flow chart of a method 400 that can be performed in connection with the request-to-pay system 100 in response to receipt of a request for a transaction from a Requester and/or a requester agent 150. The method 400 is described below in the context of being carried out by the illustrated exemplary request-to-pay system 100. However, it should be appreciated that method 400 can likewise be carried out by any of the other described implementations, as well as variations thereof. Further, the method 400 corresponds to, or is otherwise associated with, performance of the blocks described below in the illustrative sequence of FIG. 4. It should be appreciated, however, that the method 400 can be performed in one or more sequences different from the illustrative sequence. Additionally, one or more of the blocks mentioned below may not be performed, and the method 400 can include steps or processes other than those discussed below.

As seen in FIG. 4, at step 402 the Requester can, for example, by use of the requester communication device 102 and/or requester app. 114, initiate an electronic communication with a requester agent 150. The requester agent 150 can be a facilitator for the transaction being sought by the Requester. For example, according to certain embodiments, the requester agent 150 can be a financial or non-financial institution similar to the requester institution 118 discussed above. With respect to at least the illustrated example, the requester agent 150 can be a facilitator that can enable the requester located or residing in a first location, such as, for example a first country, with requesting money, including, for example, a payment, among other transfers, from a Requestee located or residing in a second location, such as, for example a second country that is different than the first country of the Requester.

In response to the request message initiated by the Requester, the requester agent 150 can collect information from the Requester regarding details of the associated transaction being requested by the Requestee. Such information can be attained by the requester agent 150 in a variety of manners, including, for example, from information provided by the Requester in the request message, prompts seeking responses from the Requester to specific questions, and/or retrieval of stored information, including, for example, information obtained from prior transactions involving the Requester and/or Requestee (e.g., from the requester/requestee database 142).

For example, according to certain embodiments, the requester agent 150 can obtain transactional details, such as, for example, a monetary amount and, optionally, the associated currency type(s) (e.g., U.S. Dollars, Nepalese Rupee, etc.) being sought by the Requester. Additionally, or alternatively, the requester agent 118 can also seek details regarding the Requester, including, for example, information that may be utilized in connection with a screening of the Requester. The types of details sought by the requester agent 150 can at least partially depend on the jurisdictions involved in the associated requested transaction. For example, according to certain embodiments, if the transaction involves an individual Requestee located or residing in the United States, the requester agent 150 can collect personal information regarding the Requester needed for a screening involving under the Know Your Customer (KYC) regulations, such as, for example, the Requester's name, address, and/or tax information, among other information. Additionally, with respect to requests involving financial transactions, the requester agent 150 can obtain payment instrument details regarding where the requested funds are to be transferred, including, for example, information regarding the bank account, electronic wallet (e.g., eWallet), or virtual payment address (e.g., VPA card) that the requested funds are to be transferred. The requester agent 150 can also collect at least contact information pertaining to the Requestee, including, for example, information regarding the name and contact information (e.g., phone number, email address, etc.).

At least the information collected by the requester agent 150 can be used by the requester agent 150 in performing a preliminary analysis, including, for example, by the controller 120, of the request being made in the request message, including with respect to one or more of the Requester, Requestee, and/or transaction. For example, as previously discussed, the information retrieved by the controller 120 from the requester/requestee database 142, among other historical databases, can indicate that the Requester is to be blocked from making requests to the identified Requestee, or otherwise has been identified as being ineligible to make such requests. Additionally, or alternatively, the initial investigation conducted using at least the controller 120 can verify the accuracy, validity, and/or completeness of the identified account to which the Requester is seeking to receive the transfer funds, including, for example, whether the identified account is dormant. Thus, in response to such a preliminary investigation, at step 404, the requester agent 150, including an associated controller 120, can generate a communication, including a notification, from the requester agent 150 to the Requester that can indicate at least a preliminary acceptance or denial of the request message, and moreover, of the request, being made by the Requester.

If the request message is at least preliminarily accepted at step 404, then at step 406 the message format or protocol of the request message, or a representation thereof, can be converted by the request message platform 106, and, moreover, the controller 120, to another format that can be associated with the type of request being made, and moreover the nature or details of the transactions being requested via the request message. For example, as previously discussed, if the request being made by the request message corresponds to a financial transaction, including, for example, a transfer of funds, then at step 406 the request message, or a representation thereof, can be converted by the request message platform 106 to a message format that is typically used for financial transactions for at least the involved jurisdiction(s). For example, in the event the request relates to a cross-border R2P transaction involving one or more parties in the United States, at step 406 the request message, or representation thereof, can be converted by the request message platform 106 to the ISO20022 message format.

At step 408, the request message, including any representations thereof, can be subjected to screening or validation by the request message platform 106. The type of screening can be at least partially based on one or more of the jurisdictions involved in the requested transaction, which can be identified by the request message platform 106. Thus, for example, with respect to certain transactions, the controller 120 can be configured to identify the transaction being a cross-border transaction involving the United States. Based on such a determination, the controller 120 can then determine the regulations or guidelines that are to be used by the request message platform 106 in screening the request, including screening of one or more of the Requester, Requestee, and/or the requested transaction. For instance, in such an example, in response to identifying an involved jurisdiction being the United States, the request message platform 106 can identify at least four screening categories for the screening or validation that is to occur at step 408, such as, for example, Know Your Customer (KYC) regulations, preliminary account validation, sanction screening, and preliminary anti money laundering (AML) and/or counter-terrorist financing (CTF) regulations or rules.

At step 410, the request message platform 106 can transmit an electronic message, including for example, via use of the ISO20022 message protocol, among other messaging protocols, to the requester agent 150 providing an indication as to whether, based on the results of the screening at step 408, the request of the Requester is being either accepted or denied by the request message platform 106. For example, one or more of the Requester, Requestee, and/or transaction being rejected as a result of the screening process at step 408 can provide a basis for the denial of the request being made by the Requester. Further, according to certain embodiments, the requester agent 150 can communicate the decision provided at step 410 to the Requester, including, for example, via a text message or email to the requester communication device 102 or associated requester app. 114.

If the request message platform 106 determines, based at least on the results of the screening at step 408, to accept the request from the Requester, then at step 412 the platform 106 can communicate a message to the Requestee, including to the requestee communication device 104 or associated requestee app. 116, providing details of the Requester's request. The Requestee can then have an opportunity to accept, accept with modification, or deny the request being made of the Requestee by the Requester, as previously discussed.

At step 414, the decision of the Requestee to accept, modify, or deny the Requester's request can be communicated from the requestee communication device 104 or associated requestee app. 116 to the request message platform 106, which may then communicate the Requestee's decision to the requester agent 150 or directly to the Requester (e.g., via the requester communication device 102 and/or requester app. 114). If the decision of the Requestee is, or results in, a denial of the Requester's request, then the platform 106 can terminate the request. If, however, the Requestee accepts the request, or accepts the request with an appropriate modification(s) (e.g., accepting a request for transferred funds but at an amount different than requested by the Requester), then at step 416 the Requestee can initiate the transaction (e.g., transfer of funds) by providing authorization of the transfer to a requestee agent 152. Similar to the requestee institution 148, the requestee agent 152 can be financial or non-financial institution, including, for example, a bank, money transfer operator (MTO), or money services business (MSB), including, for example, agents that enable a digital transfer of funds, including, but not limited to, Moneygram™, Wise™, and XUNO™, among others. With respect to cross-border requests, the requestee agent 152 can be the primary facilitator for transferring funds, including digital transfers, from the Requestee. Thus, for example, in connection with the Requestee initiating the transfer acceptance of the request, is generally indicated by step 416, be transfer details provided by the Requester, including, for example, with respect to the request at step 402 and the collection information by the requester agent 150, as previously discussed, can become available to the requestee agent 152. Accordingly, acceptance of the request by the Requestee can trigger details regarding the underlying transaction (e.g., account details for the Requester, requested amount, and/or personal information regarding the Requester, etc.) becoming available to, including provided to, the requestee agent 152.

With the acceptance of the request by the Requestee (step 416) and associated information regarding the transaction provided to the requestee agent 152, at step 418 the requestee agent 152 can proceed with transferring the requested amount to the requester agent 150. Additionally, at step 420, the requestee agent 152 can communicate a message, including, for example, via the ISO20022 protocol, to the request message platform 106 confirming the associated transaction. The request message platform 106 can then similarly provide, at step 422 a message, including, for example, via the ISO20022 protocol, to the requester agent 150 confirming the associated transaction, with the requester agent 150 providing notification of the transfer to the Requester, including, requester communication device 102 or requester app. 114 of the transaction at step 424.

The nature of the acceptance by the Requestee at step 416, as well as the associated transfer of the payout at step 418 can vary for different types of transactions. For example, with respect to at least certain P2P transactions, the Requester can provide, via the request at step 402, a request for a Requestee to transfer a particular monetary amount in one or more, including a plurality, of currencies. In certain instances, the Requestee may accept the request so that at step 418 the full amount being requested by the Requester is transferred for the Requester's account. Alternatively, the Requestee can agree to a transfer of the requested amount in installments over time. Such a modification of the Requester's request may, according to certain embodiments, involve the request message platform 106 seeking and obtaining the Requester's approval of the Requestee's modification of the request before the request message platform 106 can proceed with providing details of the underlying transaction to the requestee agent 152, as discussed above. Further, as discussed above, in such situations, the Requester can receive notifications regarding the status of the request, as well as regarding transactions relating to the transfer, as discussed above.

According to other situations come up the underlying transaction can involve a B2P or B2B transaction in which the Requester is a freelancer that, via the request at step 402, is requesting the Requestee provide a certain monetary amount in one or more, if not a plurality, of invoices to the Requestee. In certain situations, the Requester can further append one or more invoice(s) to the request that the Requester is seeking to have the Requestee pay. In certain instances, the Requestee may accept the request so that at step 418 the full amount being requested by the Requester is transferred for the Requester's account, or alternatively, the Requestee and Requester can agree to a transfer of the requested amount in installments over time, as discussed above. Additionally, the Requester can establish, with the requester agent 150, recurring payment requests on specified time periods (e.g., weekly/monthly/biweekly, etc.). Such payment requests may be ongoing, set of a select period of time, or set to terminate upon satisfaction by the Requestee of the amount owed by the Requestee to the Requester, as may be indicated by an amount indicated in the invoice(s). Further, as discussed above, in such situations, the Requester can receive notifications regarding the status of the request, as well as regarding transactions relating to the transfer, as discussed above.

According to other situations come up the underlying transaction can involve a P2B transaction in which the Requester is a merchant that, via the request at step 402, is requesting the Requestee provide a certain monetary amount in one or more, if not a plurality, of invoices to the Requestee. Optionally, in certain situations, the Requester can further append one or more merchant bill(s) to the request for payment by the Requestee. In certain instances, the Requestee may accept the request so that at step 418 the full amount being requested by the Requester is transferred for the Requester's account. Further, as discussed above, in such situations, the Requester can receive notifications regarding the status of the request, as well as regarding transactions relating to the transfer, as discussed above.

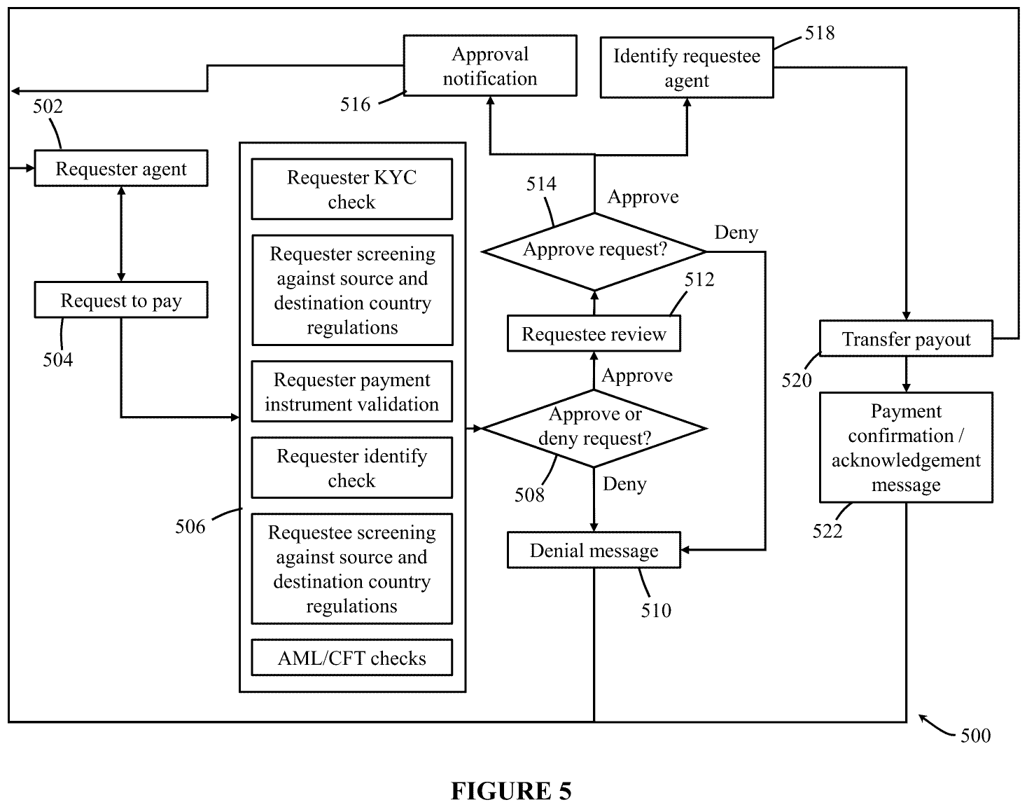

FIG. 5 illustrates a simplified flow chart of a method 500 that can be performed in connection with the request-to-pay system 100 in response to receipt of a request for a transaction from a Requester and/or from a requester agent 150. The method 500 is described below in the context of being carried out by the illustrated exemplary request-to-pay system 100. However, it should be appreciated that method 500 can likewise be carried out by any of the other described implementations, as well as variations thereof. Further, the method 500 corresponds to, or is otherwise associated with, performance of the blocks described below in the illustrative sequence of FIG. 5. It should be appreciated, however, that the method 500 can be performed in one or more sequences different from the illustrative sequence. Additionally, one or more of the blocks mentioned below may not be performed, and the method 500 can include steps or processes other than those discussed below.

The method 500, as discussed below, includes a screening module or analyzer 154 (FIG. 1) that includes a controller 120 that, via use of one or more algorithms, models, and/or look-up tables, can screen requests for cross-border financial transactions, including the nature of the transaction and the involved parties, based at least on pertinent jurisdiction rules and regulations. For example, as discussed below, the screening analyzer 154 can be configured to screen the requests based on a plurality of groups of criteria or checks. Moreover, for example, according to certain embodiments in which the transaction involves a party in the United States, the screening analyzer 154 can be configured to screen request based on at least four categories, namely, Know Your Customer (KYC) regulations, preliminary account validation, sanction screening, and preliminary anti money laundering (AML) and/or counter-terrorist financing (CTF) regulations or rules.

At block 502, the requester agent 150 can receive a request from a Requester seeking a financial transaction, such as, for example, a transfer, including, for example, a payment, of a monetary amount to the Requester from a Requestee. Additionally, in this example, the Requester, or associated requester agent 150, can be in a first country, such as, for example, Nepal, while the Requestee, or the requestee agent 152, can be in a second, different country, which in this example, can be the United States. In response to the Requester initiating the request for the financial transaction, the requester agent 150 can collect information regarding one or more of the Requester, Requestee, and/or the requested financial transaction. The information collected by the requester agent 150 can be at least similar to that discussed above with respect to at least step 402 in FIG. 4, and can be retrieved from a variety of different sources, including, for example, directly from the Requester, the request submitted by the Requester, and/or records or information stored in one or more databases regarding one or more prior transactions or interactions with the request message platform 106 involving the Requester and/or the Requestee.

The information collected by the requester agent 150 can be utilized to generate the request for pay, as indicated by block 504, that is communicated, including, for example, via the network 108, to the request message platform 106. At block 506, the request message platform 106 can perform a variety of different types or categories of screening relating to one or more of the Requester, Requestee, and/or the requested financial transaction. Moreover, the request message platform 106 can further screen either or both the Requester and Requestee with respect to regulations pertaining to the first country (e.g., designation country) and/or the second country (e.g., origin country) of the Requester/requester agent 150 and the Requestee/requestee agent 152, respectively. For example, in the illustrated example, the request message platform 106 can perform a screening regarding the Requester with respect to one or more of Know Your Customer (KYC) regulations. Additionally, or alternatively, at block 506, the request message platform 106 can conduct an analysis to confirm the actual identity of the Requester. Additionally, according to certain embodiments, to the extent not previously screened by the requester agent 150, the request message platform 106 can screen, including validate, the Requester payment instrument, including, for example, for the accuracy or completeness of the information provided, and whether the identified account to which the Requester is seeking to have funds transfer is active/inactive and/or valid/invalid. The screening performed by the request message platform 106 at block 506 can also include analysis of the requested financial transaction, such as, for example, with respect to compliance with anti-money laundering (AML) and/or counter-terrorist financing (CTF) regulations, among other rules and regulations.

Based on the outcomes of the screening performed by the request message platform 106 at block 506, the request message platform 106, including, for example, the controller 120, can decide whether to accept or deny the request being made by the Requester. If the request message platform 106 determines at block 508 that the Requester's request is to be denied, then at block 510 the request message platform 106 can generate a message to provide a notification, such as, for example, a message communicated via the network 108, to the requester agent 150 that the request has been denied, and the request can therefore be terminated. If, however, the request message platform 106 determines that, based at least on the results of the screening from block 506, the Requester's request is to be accepted, then the request message platform 106 can generate message to communicate the request to the Requestee, including, for example via an electronic message that is received by the requestee communication device 104 and/or requestee app. 116. Having received the request, the Requestee can, at block 514, utilize the requestee communication device 104 and/or requestee app. 116 to generate a signal to the request message platform 106 indicating whether the Requestee is accepting or denying the Requestor's request. If the signal generated by the requestee communication device 104 and/or requestee app. 116 indicates that the Requestee is denying the Requester's request, then, as indicated by block 510, one or more of the request message platform 106, the requestee communication device 104, and/or requestee app. 116 can generate a communication that can be communicated, such as, for example, via the network 108, to the requester agent 150 indicating the Requestee's denial of the Requester's request.

If, however, the signal received from the requestee communication device 104 and/or requestee app. 116 by at least the request message platform 106 indicates the Requestee has accepted the Requester's request, then at block 516 one or more of the request message platform 106, the requestee communication device 104, and/or requestee app. 116 can generate a communication that can be communicated, such as, for example, via the network 108, to the requester agent 150 indicating the Requestee's acceptance of the Requester's request. Additionally, at block 518, the requestee communication device 104 and/or requestee app. 116 can generate a signal in response to a command or entry by the Requestee to initiate, by the requestee agent 152, the transfer for the requested funds, which can occur at block 520. In connection with, or upon, the transfer of funds at block 510 from the requestee agent 152 to the requester agent 150 or to an intermediatory that may be associated with the request message platform 106, the requestee agent 152 can provide a notification of the transaction, including, a payment confirmation and/or acknowledgement message to one or more of the request message platform 106, requester agent 150, and/or Requestee. Additionally, or alternatively, such a notification of the transfer of funds can be electronically communicated by the request message platform 106 to the requestee agent 152.

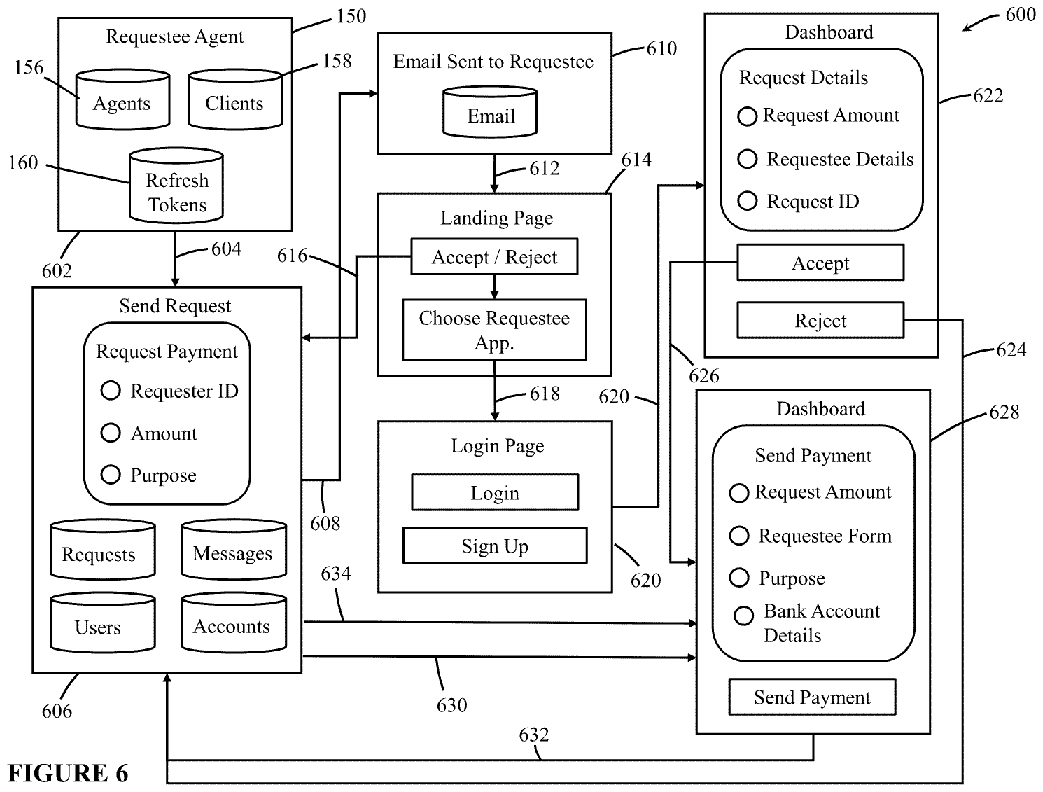

FIG. 6 illustrates a simplified flow chart of a method 600 that can be performed in connection with the request-to-pay system 100 in response to receipt of a request for a transaction from a Requester and/or a requester agent 150. The method 600 is described below in the context of being carried out by the illustrated exemplary request-to-pay system 100. However, it should be appreciated that method 600 can likewise be carried out by any of the other described implementations, as well as variations thereof. Further, the method 600 corresponds to, or is otherwise associated with, performance of the blocks described below in the illustrative sequence of FIG. 6. It should be appreciated, however, that the method 600 can be performed in one or more sequences different from the illustrative sequence. Additionally, one or more of the blocks mentioned below may not be performed, and the method 600 can include steps or processes other than those discussed below.

At block 602, one or more agents 156 of the request-to-pay system 100, including, for example, a previously discussed requester agent 150, can receive a communication from a client 158, such as, for example, a Requester via a requester communication device 102 or associated app. 114, seeking to request a transfer of a monetary amount, which can also be referred to as funds, from another party, such as, for example, a Requester. In response to such a communication, to the extent not already provided by the Requester or retrievable by the requester agent 150, the requester agent 150 can engage in one or more communications with Requester to obtain information regarding at least the Requester, Requestee, and the associated transaction, which in this example, is a financial transaction involving the transfer of funds. For at least purposes of security of the communications between the Requester and the requester agent 150, refresher tokens 160 can be utilized, including, for example, placed on the requester communication device 102.

At block 606, the request message platform 106 can receive a communication, including, for example, via the network 108, as generally indicated by line 604 in FIG. 6, providing details regarding the transaction being sought by the Requester. For example, as shown in at least FIG. 6, the communication provided that block 606 can be a request message that can request payment from the Requestee to the Requester, including from/to associated accounts. In this example, the sent request message can include identification information regarding at least the Requester, the monetary amount being requested by the Requester, and the purpose of the request. The purpose of the request can vary for different types of transactions, including, for example, requests for remittance, freelancer payments, merchant payments, business payments, or gifts, among other types of transactions. To the extent not provided by the request message, the request message platform 106 can be configured to be able to retrieve information regarding past transactions involving the Requester or user, including, for example, account, contact, and identify information regarding the Requester, and/or information regarding the identify, contact, and communication preferences for the Requestee, among other information. The request message platform 106 can also be configured to store the request message, communication threads relating to the request, information regarding prior requests, as previously discussed. As also previously discussed, at block 606, the request message platform 106 can perform one or more screenings regarding any or all of the Requester, Requestee, and the requested transaction, including, for example, using information provided by at least the above-mentioned identifier purpose of the transaction. Additionally, as also previously discussed, the request message platform 106 can also convert the request to a particular message protocol or format associated with the requested transaction, such as, for example, to the ISO20022 message format, as previously discussed.

If the request received by the request message platform 106 is approved, including, for example, successfully undergoes screening, then the request message platform 106 can communicate a message, as generally indicated by line 608, to the identified Requestee, including, for example, to an identified e-mail address, text message number, or a particular app., as may be identified by preferences of the Requestee that may be saved by the request message platform 106. Thus, in the example illustrated in FIG. 6, the Requestee can receive at block 610 information regarding the request from the request message platform 106 in the form of an e-mail message. Additionally, the message provided to the Requestee can include a unique link to a website, or to a landing page of the website (block 614), that the Requestee can, as generally indicated by line 612, be directed to via use of at least the requestee communication device 104 or associated app. 116.

The landing page can provide an entry point or gateway for the Requestee to gain access to information regarding the request. Thus, for example, at the landing page the Requestee can have an opportunity to confirm whether the Requestee seeks to access the request. Additionally, to the extent not previously provided by the Requestee to the request message platform 106, the Requestee can identify a particular requestee app. 116 that the Requestee seeks to have information regarding the request, or future requests, sent, or otherwise be viewable. Thus, of example, at block 614, the Requestee can identify an app. associated with a particular requestee agent 152 associated with the Requestee or the request-to-pay system 100 that is accessible to, or part of, the request message platform 106 to which information regarding the request can be viewed by the Requestee.

If at block 614 the Requestee indicates that the Requestee is not interested in viewing information regarding the request, then a denial message can be communicated (as generally indicated by line 616) to the request message platform 106, and the request message platform 106 can communicate an associated message notifying the requestee agent 152 and/or the Requester of the denial of the request. If, however the Requestee at block 614 indicates, via an acceptance, that the Requestee has elected to receive information regarding the request being made by the Requester, than such an acceptance can result in the Requestee being directed (as generally indicated by line 618) to a login page at block 620. The login page at block 620 can be associated with the app. selected by the Requestee at block 618. Additionally, to the extent this may be the first time the Requestee is seeking to login into the selected app., then at block 620 the Requestee can further provide information to sign up for use of the selected app.

Upon logging into the selected app., the Requestee can be directed, as generally indicated by line 620, to a dashboard provided by the website or app. that can provide information to the Requestee regarding the request being made by the Requester. A variety of different types of information can be provided to the Requestee by the dashboard at block 622, including, for example, information sent from the request message platform 106 via the ISO20022 message protocol, among other message protocols, regarding the monetary amount being requested by the Requestee, an identification of the Requester, an identification of the current or particular request being made, and/or an identification of information the request message platform 106 currently has for the Requestee, among other information. Upon review of the information provided by the dashboard, the Requestee can have an opportunity, at block 622, to either accept or deny the request. If the Requestee rejects the request, then as generally indicated by line 624 in FIG. 6, a message indicating the denial of the request can be communicated to the request message platform 106, and the platform 106 can provide notification of the denial to either or both the requester agent 150 and the Requester.

If, however, at block 622, the Requestee accepts the request being made by the Requester then, as generally indicated by line 626, the selected app. can direct the Requestee to a second dashboard at block 628, which can seek information from the Requestee regarding the requested transaction. For example, according to certain embodiments, in connection with complying with rules and regulations relating to the types of transaction being requested by the Requester, the Requestee can enter information regarding the purpose of the transaction at block 628. Additionally, according to certain apps., at block 628 the Requestee can enter account information regarding the account from which the requested funds are to be withdrawn or transferred. Further, the Requestee may be asked for personal identification information, such as, for example, be queried for a variety of different types of information, as may be identified at the second dashboard via a requestee form or template in which the Requestee is to enter details regarding the Requestee. Additionally, as generally indicated by line 630, in response to acceptance of the request at block 622, the request message platform 106 can, via the ISO20022 message protocol, among other message protocols, provide further information regarding the Requester, Requestee, and/or financial transaction for display on the second dashboard at block 628. Further, at block 628, the Requester can, via use of the selected app., provide instructions to the associated requestee agent 152 to proceed with a transfer of funds to the request message platform 106 and/or the requester agent 150, as generally indicated by line 632. Upon receipt of the funds, the request message platform 106 or requester agent 150 can send an acknowledgement message to the requestee communication device 104, the selected app. and/or the Requestee, as generally indicated by line 634.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A method for messaging communications for cross-border transactions, the method comprising:
receiving a request message from a requester agent of a requester, the request message identifying a request being made by the requester for a requestee and providing information to identify the requester;
screening the requester identified by information provided by the received request message with respect to one or more first regulations of at least one jurisdiction implicated by the request message;
screening the requestee identified from the received request message with respect to one or more second regulations of the at least one jurisdiction;
screening the request identified from the received request message with respect to one or more third regulations of the at least one jurisdiction;
converting the request from the received request message to a request message protocol based on a request type of the request and the at least one jurisdiction;
generating, in response to a result of the screenings of the requestee, requester, and the request, a signal to facilitate an electronic transmission of a request notification message to a requestee communication device of the requestee; and
communicating, using the request message protocol, information regarding the request for viewing by the requestee on the requestee communication device.

2. The method of claim 1, wherein the request message protocol is a ISO20022 message protocol.

3. The method of claim 2, wherein the one or more first regulations comprise a Know Your Customer requirement.

4. The method of claim 3, wherein the one or more third regulations comprise at least one of an anti-money laundering regulation and a counter-terrorist financing regulation.

5. The method of claim 4, wherein at screening of at least one of the requester and the requestee comprises a screening regarding sanctioned individuals or entities.

6. The method of claim 1, further comprising screening a payment instrument of the requester, wherein the payment instrument comprises an account of the requester with the requester agent.

7. The method of claim 1, wherein the request comprises a request for a transfer of funds from the requestee.

8. The method of claim 1, further comprising:
receiving a first response message from the requester communication device of the requestee, the first response message providing an indication of the requestee agreeing to review a detail of the request; and
communicating, using the request message protocol and in response to receipt of first response signal, additional information regarding the request for viewing on the requestee communication device.

9. The method of claim 8, further comprising receiving a second response signal from the requester communication device, the second response signal comprises a requester acceptance or a requester denial of the request.

10. The method of claim 9, further comprising:
monitoring, in response to the second response signal being the requester acceptance of the request, receipt of a transaction confirmation signal from a requestee agent of the requestee; and
generating, in response to an absence of a receipt of the transaction confirmation signal within a predetermined time period, a reminder communication for the requestee.

11. The method of claim 10, wherein the second response signal further comprises a modification of the request by the requestee, and wherein the method further comprises receiving a reply signal from at least one of a requester communication device of the requester or the requester agent, the reply signal comprising at least one of a requester acceptance or a requester denial of the modification of the request.

12. The method of claim 1, further comprising:
identifying, from information provided by the request message, the one or more jurisdictions, and
determining from at least the identification of the one or more jurisdictions, the one or more first regulations, the one or more second regulations, and the one or more third regulations.

13. The method of claim 1, further comprising:
identifying, from information provided by the request message, the one or more jurisdictions, and
determining from at least the identification of the one or more jurisdictions, the request message protocol.

14. A messaging system for cross-border transactions, the messaging system comprising:
request message platform comprising at least one historical database and a screening analyzer, the screening analyzer comprising at least one processor and a memory coupled with the at least one processor, the memory including instructions that when executed by the at least one processor cause the at least one processor to:
receive a request message from a requester agent of a requester, the request message identifying a request being made by the requester for a requestee and providing information to identify the requester;
screen the requester identified by information provided by the received request message with respect to one or more first regulations of at least one jurisdiction implicated by the request message;
screen the requestee identified from the received request message with respect to one or more second regulations of the at least one jurisdiction;
screen the request identified from the received request message with respect to one or more third regulations of the at least one jurisdiction;
convert the request from the received request message to a request message protocol based on a request type of the request and the at least one jurisdiction;
generate, in response to a result of the screenings of the requestee, requester, and the request, a signal to facilitate an electronic transmission of a request notification message to a requestee communication device of the requestee; and
communicate, using the request message protocol, information regarding the request for viewing by the requestee on the requestee communication device.

15. The messaging system of claim 14, wherein the request message protocol is a ISO20022 message protocol.

16. The messaging system of claim 15, wherein the one or more first regulations comprise a Know Your Customer requirement.

17. The messaging system of claim 16, wherein the one or more third regulations comprise at least one of an anti-money laundering regulation and a counter-terrorist financing regulation.

18. The messaging system of claim 17, wherein at screening of at least one of the requester and the requestee comprises a screening regarding sanctioned individuals or entities.

19. The messaging system of claim 14, further comprising screening a payment instrument of the requester, wherein the payment instrument comprises an account of the requester with the requester agent.

20. The messaging system of claim 14, wherein the request comprises a request for a transfer of funds from the requestee.
